(19) United States
(12) Patent Application Publication
(10) Pub. No.: US 2024/0066775 A1
(43) Pub. Date: Feb. 29, 2024

(54) INJECTION-MOLDING GATE CUTTING DEVICE AND GATE CUTTING METHOD

(71) Applicant: HYUNDAI MOBIS CO., LTD., Seoul (KR)

(72) Inventors: Sang Min LEE, Yongin-si (KR); Jong Dae BACK, Yongin-si (KR)

(73) Assignee: HYUNDAI MOBIS CO., LTD., Seoul (KR)

(21) Appl. No.: 18/454,965

(22) Filed: Aug. 24, 2023

(30) Foreign Application Priority Data
Aug. 31, 2022 (KR) 10-2022-0110042

(51) Int. Cl. B29C 45/38

(52) U.S. Cl. CPC B29C 45/38; B29C 2793/0027; B29C 2793/009

(57) ABSTRACT

A cylinder unit detachably coupled to a housing unit including a cutting unit detachably coupled to the cylinder unit, the cutting unit configured to move, responsive to an operation of the cylinder unit, toward an injection molding unit to cut a gate of an injection-molded object, a cover core unit detachably coupled to the injection molding unit, the cover core unit configured to face the gate, wherein the cutting unit passes through the cover core unit, and a cutting core unit detachably coupled to the cover core unit, the cutting core unit configured to face the gate, wherein the cutting unit passes through the cutting core unit.

### CROSS-REFERENCE TO RELATED APPLICATION

This application claims the benefit under 35 U.S.C. § 119(a) of priority to Korean Patent Application No. 10-2022-0110042, filed on Aug. 31, 2022 in the Korean Intellectual Property Office, the entire disclosure of which is incorporated herein by reference for all purposes.

### BACKGROUND

### 1. Field

Exemplary embodiments of the present disclosure relate to an injection-molding gate cutting device and, more particularly, to an injection-molding gate cutting device capable of being replaced in a simplified manner and preventing a crack when cutting a gate of an injection-molded object, thereby enhancing the aesthetic appeal of the exterior appearance of an injection-molded product.

### 2. Discussion of the Related Art

Usually, vehicular components are manufactured by injection molding. The vehicular components are manufactured using an injection molding apparatus. An injection-molded object is produced by injecting resin into a mold. At this time, a gate of the injection-molded object is formed. The gate of the injection-molded object is cut in a state where the injection-molded object is cooled and takes on the desired shape. At this point, the gate may be cut using a cutting device coupled to the injection molding apparatus. However, the entire injection molding apparatus requires disassembly when replacing a component of the cutting device, leading to increased replacement time and higher component costs. In addition, a crack may occur in the injection-molded object because the gate of the injection-molded object is cut in the state where the injection-molded object is cooled and takes on the desired shape. The presence of the crack can adversely affect the product's exterior appearance, thereby compromising its overall quality. Therefore, there is a need to find a solution to this problem.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a cylinder unit detachably coupled to a housing unit including a cutting unit detachably coupled to the cylinder unit, the cutting unit configured to move, responsive to an operation of the cylinder unit, toward an injection molding unit to cut a gate of an injection-molded object, a cover core unit detachably coupled to the injection molding unit, the cover core unit arranged to face the gate, wherein the cutting unit is arranged to be capable of passing through the cover core unit, and a cutting core unit detachably coupled to the cover core unit, the cutting core unit configured to face the gate, wherein the cutting unit passes through the cutting core unit.

The cutting unit may be configured to cut the gate during a process of maintaining a holding pressure inside the injection molding unit.

The device may include a plurality of cutting position adjustment units configured to adjust a position of the cutting unit by supporting the cutting unit, wherein one or more of the plurality of cutting position adjustment units are positioned on a top of the cylinder unit.

The cylinder unit may include cylinder main body installed in the housing unit, a cylinder rod movably coupled to the cylinder main body, the cylinder rod being configured to move toward the injection molding unit when a hydraulic pressure is generated in the cylinder main body or to move away from the injection molding unit when the hydraulic pressure is no longer generated, the cylinder rod being connected to the cutting unit, and a position fixation block connected to the cylinder rod and configured to fix the position of the cutting unit by being inserted into the cutting unit.

The cutting unit may include a cutting block having an insertion groove defined therein and configured to receive the position fixation block, the cutting block being positioned to face the cylinder rod, a cutting blade connected to the cutting block and configured to cut the gate, and a cutting coupling portion configured to couple the cutting block to the cylinder rod.

The cutting position adjustment units may be plate-shaped and have a through-hole defined therein to receive the cutting coupling portion, the cutting coupling portion being configured to pass through the through-hole, and the cutting position adjustment unit may include a passing-through hole defined therein to receive the position fixation block, the position fixation block being configured to pass through the passing-through hole.

The cutting core unit may include a same material as a material of the cutting unit.

The cover core unit may include a cover core main body detachably coupled to the injection molding unit and having a first gate groove defined therein facing the gate and a cover core extension block having a first passing-through hole defined therein through which the cutting unit passes, the cover core extension block being connected to the cover core main body and the first gate groove and being configured to support the cutting core unit.

The cutting core unit may include a cutting core protrusion inserted into an insertion groove in the cover core main body, a cutting core main body having a second gate groove defined therein connected to the first gate groove and a second passing-through hole defined therein through which the cutting unit is configured to pass, the cutting core main body being connected to the cutting core protrusion, the cutting core main body being supported by the cover core extension block and facing the gate, and a coupling portion configured to couple the cutting core main body and the cover core main body to each other.

The housing unit may include a first housing unit configured to support the injection molding unit, the cylinder unit being mounted in the first housing unit and a second housing unit coupled to the first housing unit, a lower portion of the cylinder unit being arranged inside the second housing unit, and a fluid, which leaks from the cylinder unit, flowing into the second housing unit.

In a general aspect, here is provided a method including clamping an injection molding unit, producing an injection-molded object by injecting resin into the injection molding unit, maintaining a holding pressure inside the injection molding unit, cutting a gate of the injection-molded object, cooling the injection-molded object, and ejecting the injection-molded object.

In the cutting of the gate of the injection-molded object, the gate may be cut by an injection-molding gate cutting device.

The injection-molding gate cutting device may include a cylinder unit detachably coupled to a housing unit, a cutting unit detachably coupled to the cylinder unit and configured to move by an operation of the cylinder unit toward an injection molding unit to cut the gate of an injection-molded object, a cover core unit detachably coupled to the injection molding unit and configured to face the gate, the cutting unit passing through the cover core unit, and a cutting core unit detachably coupled to the cover core unit and configured to face the gate, the cutting unit passing through the cutting core unit.

The cutting of the gate of the injection-molded object may be performed during the maintaining of the holding pressure inside the injection molding unit.

The cutting of the gate of the injection-molded object may be performed after the maintaining of the holding pressure inside the injection molding unit.

In a general aspect, here is provided a device including a cutting unit configured to move, responsive to an operation of a cylinder unit, toward an injection molding unit to cut a gate of an injection-molded object, a cover core unit configured to face the gate, wherein the cutting unit passes through the cover core unit, and a cutting core unit configured to face the gate, wherein the cutting unit passes through the cutting core unit.

The cover core unit may be detachably coupled to the injection molding unit.

The cutting core unit may be detachably coupled to the cover core unit.

The cylinder unit may be detachably coupled to a housing unit.

The cover core unit may include a cover core main body having a first gate groove defined therein facing the gate and a cover core extension block having a first passing-through hole defined therein through which the cutting unit passes and being configured to support the cutting core unit.

### BRIEF DESCRIPTION OF THE DRAWINGS

FIG. 1 is a perspective view illustrating an injection molding apparatus according to an embodiment of the present disclosure.

FIG. 2 is a cross-sectional view illustrating the injection molding apparatus according to the embodiment of the present disclosure.

FIG. 3 is an exploded perspective view illustrating the injection molding apparatus according to the embodiment of the present disclosure.

FIG. 4 is a perspective view illustrating essential components of the injection molding apparatus according to the embodiment of the present disclosure.

FIG. 5 is a perspective view illustrating the essential components of the injection molding apparatus according to the embodiment of the present disclosure in FIG. 4, when viewed from a different direction.

FIG. 6 is an enlarged view illustrating Portion A of FIG. 5.

FIG. 7 is a cross-sectional view taken along line B-B′ on FIG. 6.

FIG. 8 is a perspective view illustrating an injection-molding gate cutting device according to an embodiment of the present disclosure.

FIG. 9 is a perspective view illustrating the injection-molding gate cutting device according to the embodiment of the present disclosure, when viewed from a different direction.

FIG. 10 is a side view illustrating the injection-molding gate cutting device according to the embodiment of the present disclosure.

FIG. 11 is an exploded perspective view illustrating the injection-molding gate cutting device according to the embodiment of the present disclosure.

FIGS. 12A and 12B are a view illustrating that the injection-molding gate cutting device according to the embodiment of the present disclosure cuts a gate of an injection-molded object.

FIG. 13 is a flowchart illustrating a gate cutting method according to an embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

An injection molding apparatus 1, an injection-molding gate cutting device 2, and a gate cutting method according to embodiments, respectively, of the present disclosure will be described below with reference to the accompanying drawing.

For clarity and convenience in description, thicknesses of lines, sizes of constituent elements, and the like may be illustrated in non-exact proportion in the drawings. In addition, a term defined by considering a function of a constituent element according to the present disclosure to which the term is assigned will be used below and may vary according to a user's or manager's intention or to practices in the art. Therefore, the term should be defined in context in light of the present specification.

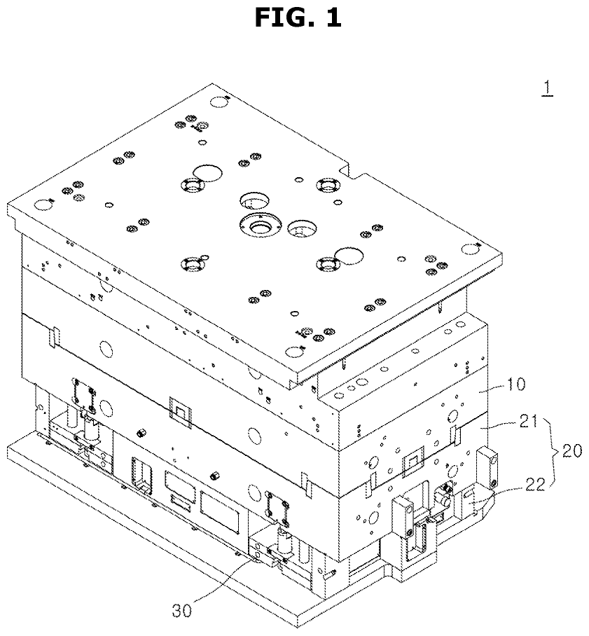

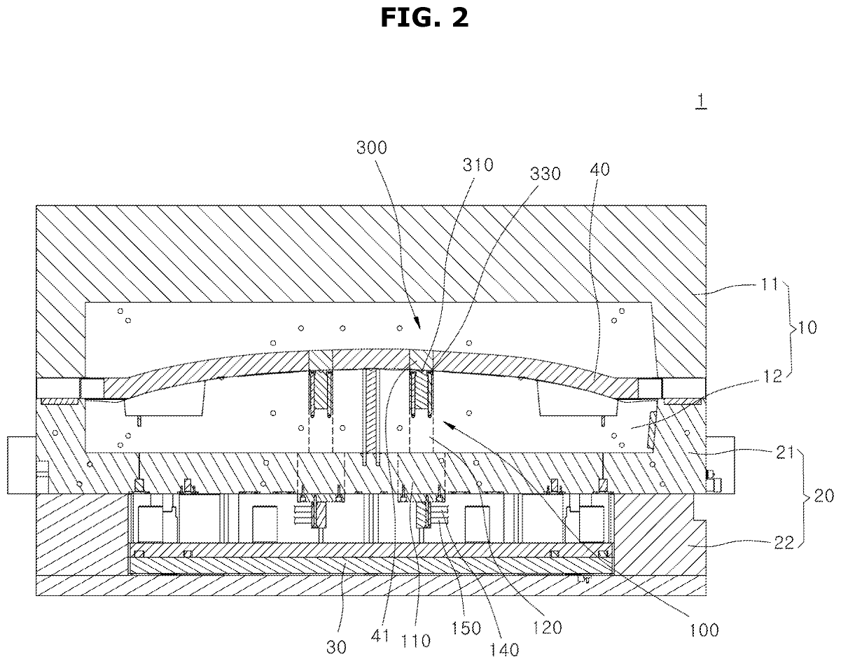

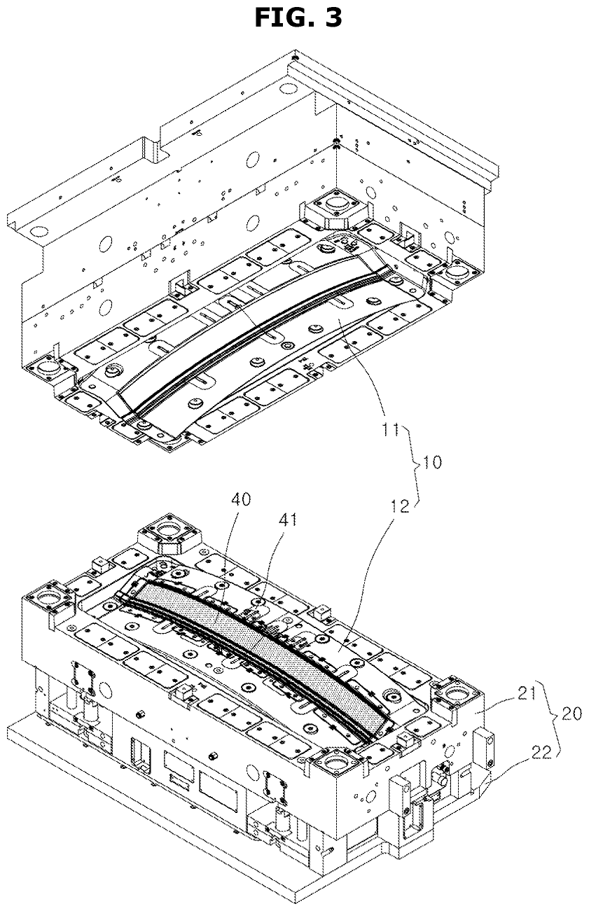

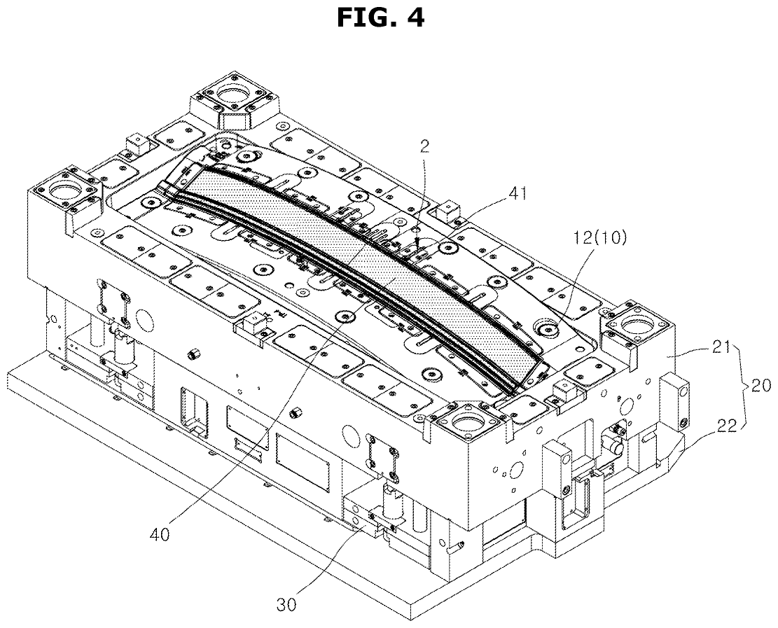

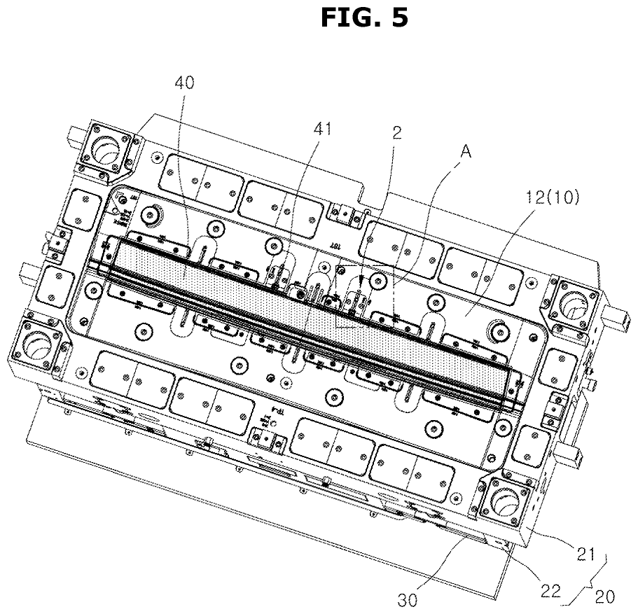

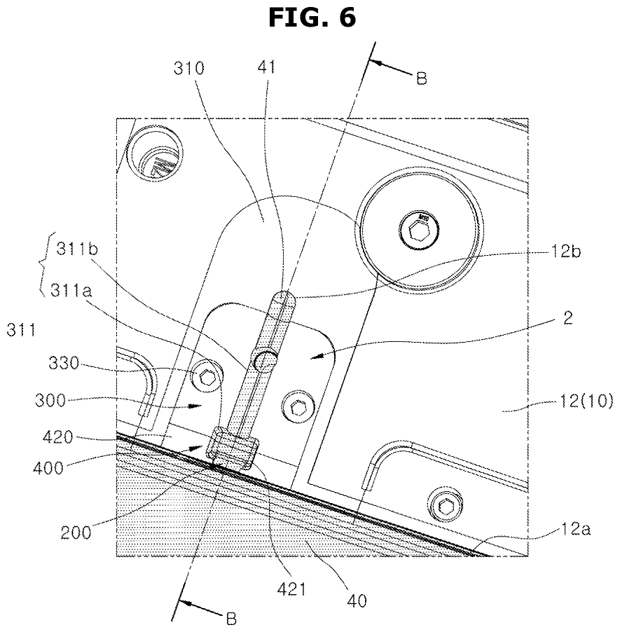

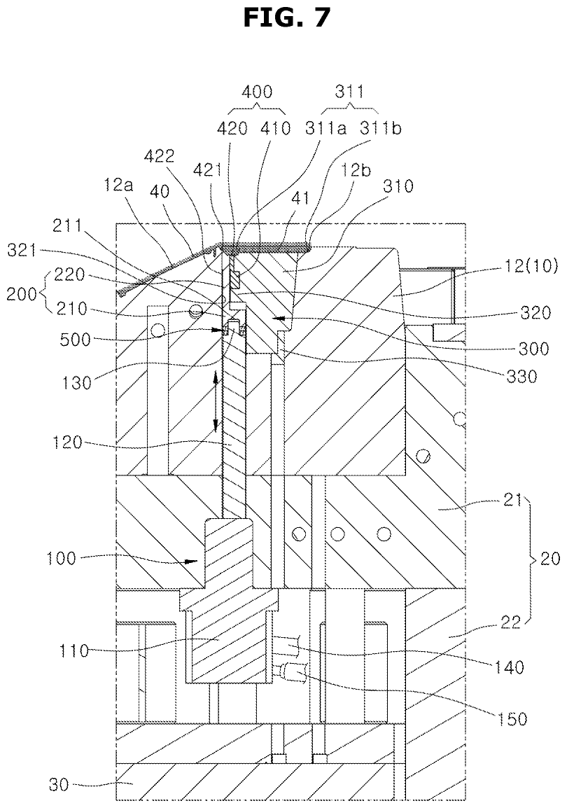

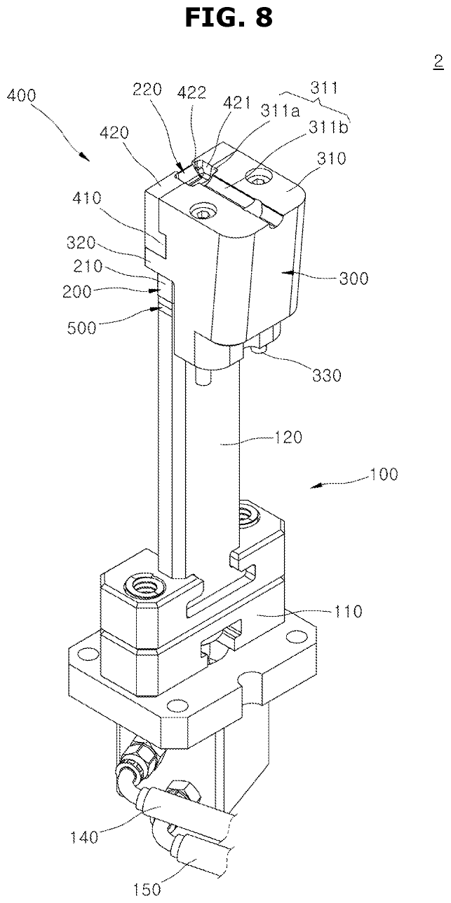

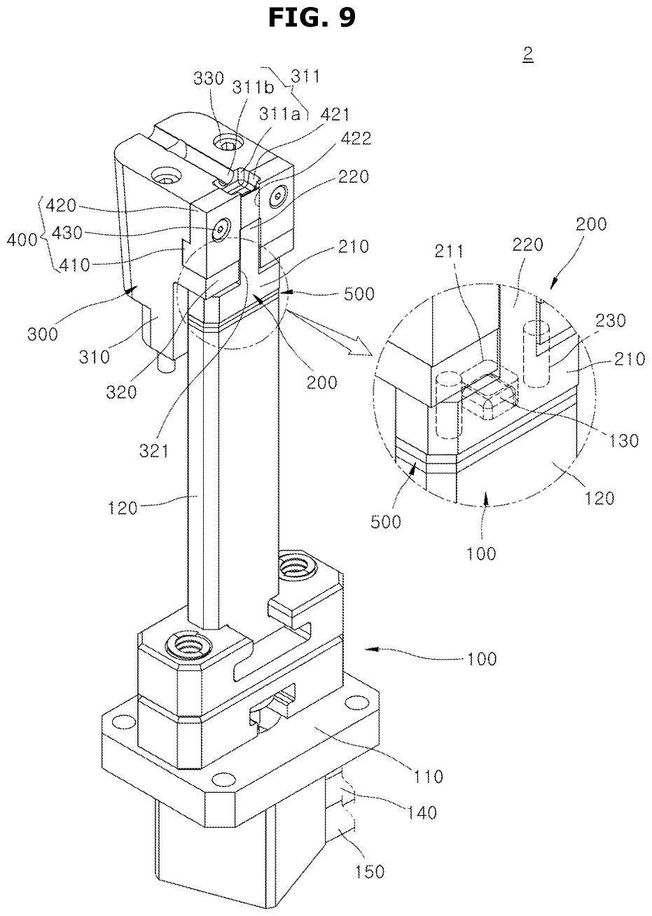

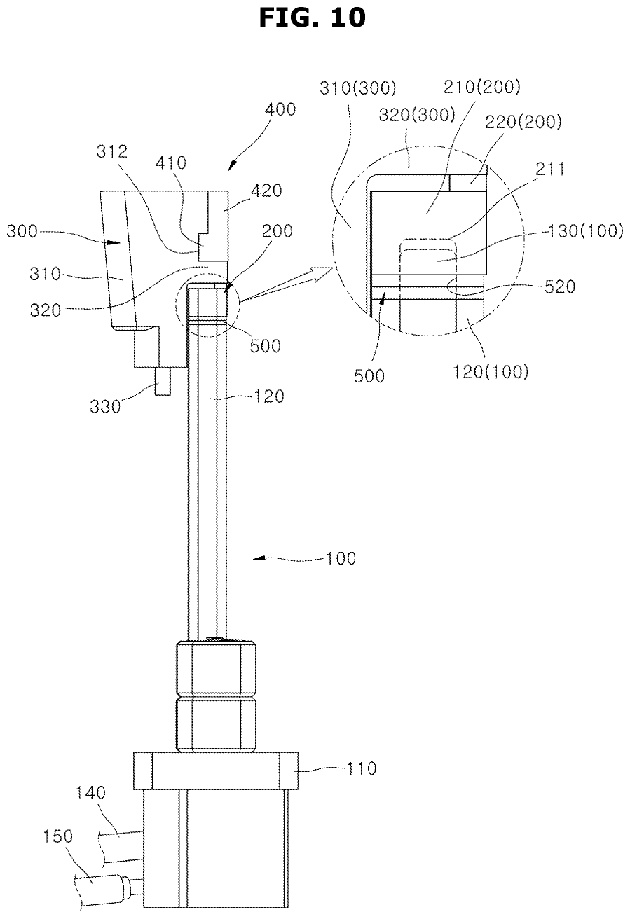

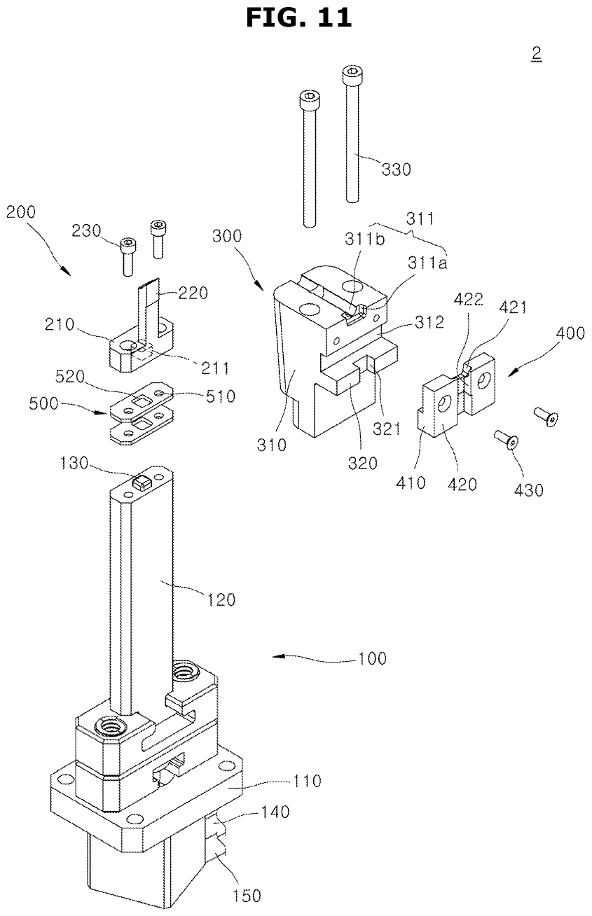

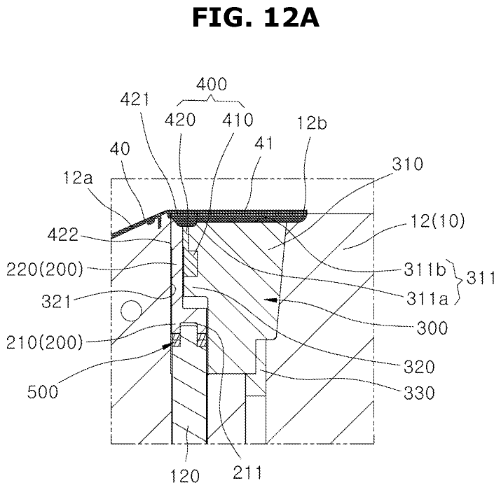

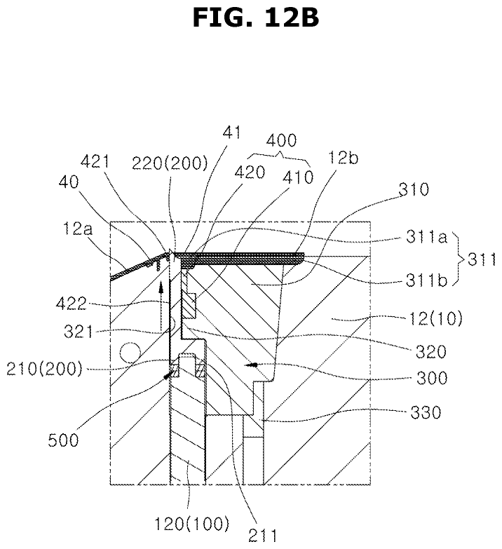

FIG. 1 is a perspective view illustrating an injection molding apparatus 1 according to the embodiment of the present disclosure. FIG. 2 is a cross-sectional view illustrating the injection molding apparatus 1 according to the embodiment of the present disclosure. FIG. 3 is an exploded perspective view illustrating the injection molding apparatus 1 according to the embodiment of the present disclosure. FIG. 4 is a perspective view illustrating essential components of the injection molding apparatus 1 according to the embodiment of the present disclosure. FIG. 5 is a perspective view illustrating the essential components of the injection molding apparatus 1 according to the embodiment of the present disclosure in FIG. 4, when viewed from a different direction. FIG. 6 is an enlarged view illustrating Portion A of FIG. 5. FIG. 7 is a cross-sectional view taken along line B-B′ on FIG. 6. FIG. 8 is a perspective view illustrating the injection-molding gate cutting device 2 according to the second embodiment of the present disclosure. FIG. 9 is a perspective view illustrating the injection-molding gate cutting device 2 according to the embodiment of the present disclosure, when viewed from a different direction. FIG. 10 is a side view illustrating the injection-molding gate cutting device 2 according to the embodiment of the present disclosure. FIG. 11 is an exploded perspective view illustrating the injection-molding gate cutting device 2 according to the embodiment of the present disclosure. FIGS. 12A and 12B are a view illustrating that the injection-molding gate cutting device 2 according to the embodiment of the present disclosure cuts a gate of an injection-molded object 40.

With reference to FIGS. 1 to 3, the injection molding apparatus 1 according to the embodiment of the present disclosure includes an injection molding unit 10, a housing unit 20, an ejection unit 30, and the injection-molding gate cutting device 2. The injection molding unit 10 performs injection molding to produce the injection-molded object 40. The injection molding unit 10 includes an upper injection molding unit 11 and a lower injection molding unit 12. The upper injection molding unit 11 and the lower injection 12 are brought into close contact with each other for secure closing to form a mold cavity for the injection-molded object 40. After the upper injection molding unit 11 and the lower injection molding unit 12 are brought into close contact with each other for secure closing, resin is injected into the mold cavity to produce the injection-molded object 40.

The housing unit 20 supports the injection molding unit 10 that performs the injection molding to produce the injection-molded object 40. The housing unit 20 includes a first housing unit 21 and a second housing unit 22. The first housing unit 21 supports the injection molding unit 10, and a cylinder unit 100 is mounted in the first housing unit 21. The lower injection molding unit 12 of the injection molding unit 10 is positioned on top of the first housing unit 21, and the first housing unit 21 supports the lower injection molding unit 12.

The second housing unit 22 is coupled to the first housing unit 21. A lower portion of the cylinder unit 100 is arranged inside the second housing unit 22. A fluid that leaks from the cylinder unit 100 flows into the second housing unit 22. The fluid here refers to oil.

In this manner, the flowing of the fluid leaking from the cylinder unit 100 into the second housing unit 22 of the housing unit 20 can block the fluid from flowing to the injection molding unit 10 positioned on top of the first housing unit 21 of the housing unit 20. Accordingly, damage to the injection molding apparatus 1 may be minimized.

The ejection unit 30 is installed in the housing unit 20 in a manner that is enabled to ascend and descend. The ejection unit 30 presses against the injection-molded object 40 in the injection molding unit 10, thereby ejecting the injection-molded object 40.

The injection-molding gate cutting device 2 is positioned under a lower injection molding gate 12b of the lower injection molding unit 12. The injection-molding gate cutting device 2 moves toward the lower injection molding gate 12b to cut a gate 41 of the injection-molded object 40. The lower injection molding gate 12b is connected to a lower injection molding main body 12a through a cover core unit 300 and a cutting core unit 400 of the injection-molding gate cutting device 2 describe below. That is, the lower injection molding gate 12b is connected to the lower injection molding main body 12a through a first gate groove 311 in the cover core unit 300 and a second gate groove 421 in the cutting core unit 400.

The first gate groove 311 includes a first sub-gate groove 311a and a second sub-gate groove 311b. The first sub-gate groove 311a is arranged to face the second gate groove 421. The second sub-gate groove 311b is connected to the first sub-gate groove 311a and is arranged to face the lower injection molding gate 12b.

With reference to FIGS. 4 to 12, the injection-molding gate cutting device 2 includes the cylinder unit 100, a cutting unit 200, the cover core unit 300, the cutting core unit 400, and a cutting position adjustment unit 500. The cylinder unit 100 is detachably coupled to the housing unit 20. The cylinder unit 100 is coupled to the first housing unit 21 of the housing unit 20 in a manner that enables it to be decoupled, and is movable in an upward-downward direction (with respect to upright positions of the injection molding apparatus 1 in FIGS. 2 and 7, and the injection-molding gate cutting device 2 in FIGS. 12A and 12B).

As a result, the detachable coupling of the cylinder unit 100 to the first housing unit 21 of the housing unit 20 allows for easily separating the cylinder unit 100 from the first housing unit 21 of the housing unit 20 for replacement when the cylinder unit 100 is damaged.

The cylinder unit 100 includes a cylinder main body 110, a cylinder rod 120, a position fixation block 130, a first valve 140, and a second valve 150. The cylinder main body 110 is installed in the housing unit 20. Hydraulic pressure is generated in the cylinder main body 110 or is no longer generated therein. An upper portion of the cylinder main body 110 is installed in the first housing unit 21 of the housing unit 20, and a lower portion thereof is arranged in the second housing unit 22 of the housing unit 20.

The cylinder rod 120 is movably coupled to the cylinder main body 110. The cylinder rod 120 moves toward the injection molding unit 10 when the hydraulic pressure is generated in the cylinder main body 110 or moves away from the injection molding unit 10 when the hydraulic pressure is no longer generated. The cylinder rod 120 is connected to the cutting unit 200.

Specifically, the cylinder rod 120 is coupled to the cylinder main body 110 in a manner that is movable in the upward-downward direction (with respect to the upright positions of the injection molding apparatus 1 in FIGS. 2 and 7, and the injection-molding gate cutting device 2 in FIGS. 12A and 12B). Furthermore, the cylinder rod 120 may move upward (with respect to the upright positions of the injection molding apparatus 1 in FIGS. 2 and 7, and the injection-molding gate cutting device 2 in FIGS. 12A and 12B) with the hydraulic pressure generated in the cylinder main body 110 or may move downward (with respect to the upright positions of the injection molding apparatus 1 in FIGS. 2 and 7, and the injection-molding gate cutting device 2 in FIGS. 12A and 12B) when the hydraulic pressure is no longer generated in the cylinder main body 110.

The position fixation block 130 is connected to the cylinder rod 120 and is inserted into the cutting unit 200, thereby fixing a position of the cutting unit 200.

The first valve 140 is connected to the cylinder main body 110. The fluid may flow into the cylinder main body 110. The first valve 140 is connected to a lower portion of the cylinder main body 110 and is arranged on top of the second housing unit 22 of the housing unit 20.

The second valve 150 is connected to the cylinder main body 110. The fluid is discharged from the cylinder main body 110. The second valve 150 is connected to the lower portion of the cylinder main body 110 and is arranged on top of the second housing unit 22 of the housing unit 20.

The cutting unit 200 is detachably coupled to the cylinder unit 100 in a manner that moves by operation of the cylinder unit 100 toward the injection molding unit 10 to cut the gate 41 of the injection-molded object 40. The cutting unit 200 moves in the upward-downward direction (with respect to the upright positions of the injection molding apparatus 1 in FIGS. 2 and 7, and the injection-molding gate cutting device 2 in FIGS. 12A and 12B) by the operation of the cylinder unit 100. While maintaining a holding pressure inside the injection molding unit 10, the cutting unit 200 moves upward (with respect to the upright positions of the injection molding apparatus 1 in FIGS. 2 and 7, and the injection-molding gate cutting device 2 in FIGS. 12A and 12B) to cut the gate 41.

The detachable coupling of the cutting unit 200 to the cylinder unit 100 allows for separating peripheral components, including the cutting unit 200, and for replacing the cutting unit 200. This eliminates the need to disassemble all components, when the cutting unit 200 is damaged. Accordingly, simplification of a process of replacing the cutting unit 200 can lead to a reduction in replacement time and component costs.

The cutting unit 200 includes a cutting block 210, a cutting blade 220, and a cutting coupling portion 230. The cutting block 210 is positioned to face the cylinder rod 120. The position fixation block 130 has an insertion groove 211 into which the position fixation block 130 is inserted. The cutting block 210 is coupled to the cylinder rod 120 with the cutting coupling portion 230 in between.

The cutting blade 220 is connected to the cutting block 210 to cut the gate 41. The cutting blade 220, together with the cutting block 210, moves toward the injection molding unit 10 of the injection molding apparatus 1, that is, moves upward (with respect to the upright position of the injection-molding gate cutting device 2 in FIGS. 12A and 12B) to cut the gate 41 of the injection-molded object 40 produced in the injection molding unit 10.

The cutting coupling portion 230 couples the cutting block 210 to the cylinder rod 120. The cutting coupling portion 230 couples the cutting block 210 and the cylinder rod 120 in a bolt-nut fastening manner.

The cover core unit 300 is detachably coupled to the injection molding unit 10. The cover core unit 300 faces the gate 41, and the cutting unit 200 passes through the cover core unit 300. The cover core unit 300 is detachably coupled to the lower injection molding unit 12 of the injection molding unit 10.

The detachable coupling of the cover core unit 300 to the injection molding unit 10 allows for separating peripheral components, including the cover core unit 300, and for replacing the cover core unit 300. This eliminates the need to disassemble all components when reciprocating motions of the cutting unit 200 causes friction, leading to damage to the cover core unit 300. Accordingly, simplification of a process of replacing the cover core unit 300 can lead to a reduction in replacement time and component costs.

The cover core unit 300 includes a cover core main body 310 and a cover core extension block 320. The cover core main body 310 is detachably coupled to the injection molding unit 10 and has the first gate groove 311 that faces the gate 41. The cover core main body 310 is detachably coupled to the lower injection molding unit 12 of the injection molding unit 10. The cover core main body 310 has an insertion groove 312 into which a cutting core protrusion 410 of the cutting core unit 400 is inserted.

The cover core extension block 320 has a first passing-through hole 321 through which the cutting unit 200 passes. The cover core extension block 320 is connected to the cover core main body 310 and supports the cutting core unit 400 described below. The cover core extension block 320 is formed to extend from the cover core main body 310 and supports a lower portion of the cutting core unit 400.

The cutting core unit 400 is detachably coupled to the cover core unit 300 in a manner that faces the gate 41. The cutting unit 200 passes through the cutting core unit 400. The cutting core unit 400 is formed of the same material as the cutting unit 200. In this case, the cutting core unit 400 may be formed of the same heat-treated metal material as the cutting unit 200. The wearing of the cutting core unit 400 by the cutting unit 200 can be minimized.

The cutting core unit 400 includes the cutting core protrusion 410, a cutting core main body 420, and a coupling portion 430. The cutting core protrusion 410 is inserted into the insertion groove 312 in the cover core main body 310. Accordingly, the cutting core unit 400 may be pre-assembled before coupled to the cover core unit 300 and thus the cutting core unit 400 may be easily coupled to the cover core unit 300 through the coupling portion 430.

The cutting core main body 420 is connected to the cutting core protrusion in a manner that is supported by the cover core extension block 320 and in a manner that faces the gate 41. The cutting core main body 420 includes the second gate groove 421 that is connected the first gate groove 311, and a second passing-through hole 422 through which the cutting unit 200 passes.

The coupling portion 430 couples the cutting core main body 420 and the cover core main body 310 to each other. The coupling portion 430 is coupled to the cutting core main body 420 and the cover core main body 310 with a bolt in a bolt-nut fastening manner.

The detachable coupling of the cutting core unit 400 to the cover core unit 300 allows for separating peripheral components, including the cutting core unit 400, and for replacing the cutting core unit 400, when the reciprocating motions of the cutting unit 200 causes friction, leading to damage to the cutting core unit 400. Accordingly, simplification of a process of replacing the cutting core unit 400 can lead to a reduction in replacement time and component costs.

As described above, the detachable coupling of the injection-molding gate cutting device 2 to the injection molding apparatus 1 allows for being replaced only by a partial disassembling operation without the need to disassemble all components of the injection molding apparatus 1. This can simplify a process of replacing the injection-molding gate cutting device 2, leading to a reduction in replacement time and component costs.

Any one of a plurality of cutting position adjustment units 500 is positioned on top of the cylinder unit 100. The plurality of cutting position adjustment units 500 adjust the position of the cutting unit 200 by supporting the cutting unit 200. The cutting position adjustment unit 500 is plate-shaped and has a through-hole 510 for the cutting coupling portion 230 and a passing-through hole 520 for the position fixation block 130. The cutting coupling portion 230 in the cutting unit 200 passes through the through-hole 510 for the cutting coupling portion 230. In this case, the cutting coupling portion 230 passes through the cutting block 210 and the through-hole 510 for the cutting coupling portion 230 in the cutting position adjustment unit 500 and is coupled to the cylinder rod 120 of the cylinder unit 100.

Accordingly, the cutting position adjustment unit 500 may be arranged between the cylinder unit 100 and the cutting unit 200 and may be coupled to the cylinder unit 100 and the cutting unit 200.

The position fixation block 130 passes through the passing-through hole 520 for the position fixation block 130. In this case, the passing-through hole 520 for the position fixation block 130 is shaped to correspond with a shape of the position fixation block 130. That is, the passing-through hole 520 for the position fixation block 130 may be polygon-shaped to correspond with a polygonal shape of the position fixation block 130.

Thus, by adjusting the position of the cutting unit 200 according to the situation, an operator can adjust a distance over which the cutting unit 200 protrudes toward the gate 41 of the injection-molded object 40. Accordingly, performance in cutting the gate 41 of the injection-molded object 40 can be improved.

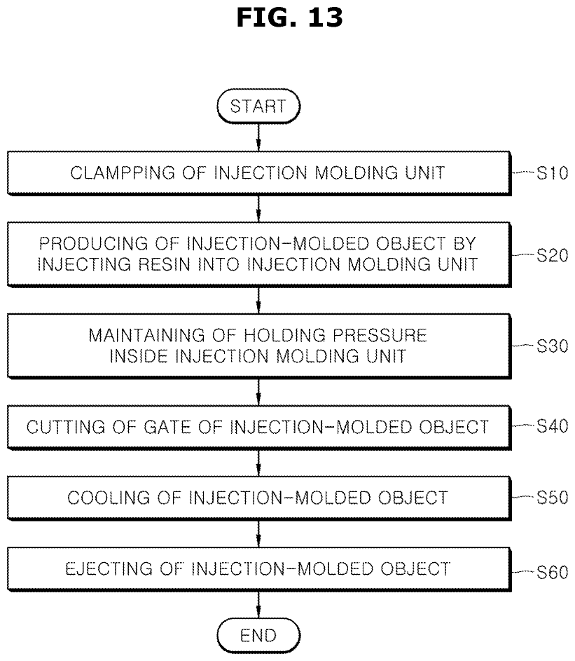

FIG. 13 a flowchart illustrating the gate cutting method according to an embodiment of the present disclosure. The gate cutting method according to the embodiment of the present disclosure will be described below with reference to FIG. 13.

The gate cutting method includes a clamping step S10, an injection step S20, and a holding pressure maintaining step S30, a cutting step S40, a cooling step S50, and an ejection step S60. In the clamping step S10, the injection molding unit 10 is clamped. In the clamping step S10, the upper injection molding unit 11 of the injection molding unit 10 and the lower injection molding unit 12 of the injection molding unit 10 may be brought into close contact with each other for clamping.

In the injection step S20, the injection-molded object 40 is produced by injecting resin into the injection molding unit 10. In the injection step S20, resin is injected into the clamped injection molding unit 10, and then the injection-molded object 40 is produced. In the injection step S20, an injection pressure is applied to produce the injection-molded object 40.

In the holding pressure maintaining step S30, the holding pressure inside the injection molding unit 10 is maintained. In the holding pressure maintaining step S30, the holding pressure inside the injection molding unit 10 is maintained by applying a predetermined pressure to the inside of the injection molding unit 10. At this point, the holding pressure can be maintained for three to five minutes.

In the cutting step S40, the gate 41 of the injection-molded object 40 is cut. In the cutting step S40, the gate 41 is cut through the injection-molding gate cutting device 2.

The cutting step S40 may be performed in the holding pressure maintaining step S30. At this point, the cutting step S40 may be performed for approximately four seconds in the holding pressure maintaining step S30.

The cutting step S40 may be performed either during the holding pressure maintaining step S30 or after the holding pressure maintaining step S30, but before the cooling step S50 described below.

In the cooling step S50, the injection-molded object 40 is cooled. In the cooling step S50, the injection-molded object from which the gate 41 is removed by cutting is cooled for a preset time. Through the cooling step S50, the injection-molded object 40 takes on the desired shape and solidifies, resulting in being manufactured into an injection-molded product.

In the ejection step S60, the injection-molded object 40 is ejected. In the ejection step S60, the cooled injection-molded object 40 is ejected and thus separated from the injection molding apparatus 1. Accordingly, the finished injection-molded product is easily separated from the injection molding apparatus 1.

In the gate cutting method according to the present disclosure, the cutting step S40 of cutting the gate 41 of the injection-molded object 40 is performed in the holding pressure maintaining step S30. Thus, when cutting the gate 41 of the injection-molded object 40, a crack can be prevented from occurring in the injection-molded object 40. Accordingly, this can enhance the aesthetic appeal of the exterior appearance of the injection-molded product.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A device, comprising:
a cylinder unit detachably coupled to a housing unit;
a cutting unit detachably coupled to the cylinder unit, the cutting unit configured to move, responsive to an operation of the cylinder unit, toward an injection molding unit to cut a gate of an injection-molded object;
a cover core unit detachably coupled to the injection molding unit, the cover core unit arranged to face the gate, wherein the cutting unit is arranged to be capable of passing through the cover core unit; and
a cutting core unit detachably coupled to the cover core unit, the cutting core unit arranged to face the gate, wherein the cutting unit is configured to be capable of passing through the cutting core unit.

2. The device of claim 1, wherein the cutting unit is configured to cut the gate during a process of maintaining a holding pressure inside the injection molding unit.

3. The device of claim 1, further comprising:
a plurality of cutting position adjustment units configured to adjust a position of the cutting unit by supporting the cutting unit, wherein one or more of the plurality of cutting position adjustment units are positioned on a top of the cylinder unit.

4. The device of claim 3, wherein the cylinder unit comprises:
a cylinder main body installed in the housing unit;
a cylinder rod movably coupled to the cylinder main body, the cylinder rod being configured to move toward the injection molding unit when a hydraulic pressure is generated in the cylinder main body or to move away from the injection molding unit when the hydraulic pressure is no longer generated, the cylinder rod being connected to the cutting unit; and
a position fixation block connected to the cylinder rod and configured to fix the position of the cutting unit by being inserted into the cutting unit.

5. The device of claim 4, wherein the cutting unit comprises:
a cutting block having an insertion groove defined therein and configured to receive the position fixation block, the cutting block being positioned to face the cylinder rod;
a cutting blade connected to the cutting block and configured to cut the gate; and
a cutting coupling portion configured to couple the cutting block to the cylinder rod.

6. The device of claim 5, wherein the cutting position adjustment units are plate-shaped and have a through-hole defined therein to receive the cutting coupling portion, the cutting coupling portion being configured to pass through the through-hole, and
wherein the cutting position adjustment unit has a passing-through hole defined therein to receive the position fixation block, the position fixation block being configured to pass through the passing-through hole.

7. The device of claim 1, wherein the cutting core unit comprises a same material as a material comprising the cutting unit.

8. The device of claim 1, wherein the cover core unit comprises:
a cover core main body detachably coupled to the injection molding unit and having a first gate groove defined therein facing the gate; and
a cover core extension block having a first passing-through hole defined therein through which the cutting unit passes, the cover core extension block being connected to the cover core main body and the first gate groove and being configured to support the cutting core unit.

9. The device of claim 8, wherein the cutting core unit comprises:
a cutting core protrusion inserted into an insertion groove in the cover core main body;
a cutting core main body having a second gate groove defined therein connected to the first gate groove and a second passing-through hole defined therein through which the cutting unit is configured to pass, the cutting core main body being connected to the cutting core protrusion, the cutting core main body being supported by the cover core extension block and facing the gate; and
a coupling portion configured to couple the cutting core main body and the cover core main body to each other.

10. The device of claim 1, wherein the housing unit comprises:
a first housing unit configured to support the injection molding unit, the cylinder unit being mounted in the first housing unit; and
a second housing unit coupled to the first housing unit, a lower portion of the cylinder unit being arranged inside the second housing unit, and a fluid, which leaks from the cylinder unit, flowing into the second housing unit.

11. A method, the method comprising:
clamping an injection molding unit;
producing an injection-molded object by injecting resin into the injection molding unit;
maintaining a holding pressure inside the injection molding unit;
cutting a gate of the injection-molded object;
cooling the injection-molded object; and
ejecting the injection-molded object.

12. The method of claim 11, wherein, in the cutting of the gate of the injection-molded object, the gate is cut by an injection-molding gate cutting device.

13. The method of claim 12, wherein the injection-molding gate cutting device comprises:
a cylinder unit detachably coupled to a housing unit;
a cutting unit detachably coupled to the cylinder unit and configured to move by an operation of the cylinder unit toward an injection molding unit to cut the gate of an injection-molded object;
a cover core unit detachably coupled to the injection molding unit and configured to face the gate, the cutting unit passing through the cover core unit; and
a cutting core unit detachably coupled to the cover core unit and configured to face the gate, the cutting unit passing through the cutting core unit.

14. The method of claim 11, wherein the cutting of the gate of the injection-molded object is performed during the maintaining of the holding pressure inside the injection molding unit.

15. The method of claim 11, wherein the cutting of the gate of the injection-molded object is performed after the maintaining of the holding pressure inside the injection molding unit.

16. A device, comprising:
a cutting unit configured to move, responsive to an operation of a cylinder unit, toward an injection molding unit to cut a gate of an injection-molded object;
a cover core unit configured to face the gate, wherein the cutting unit passes through the cover core unit; and
a cutting core unit configured to face the gate, wherein the cutting unit passes through the cutting core unit.

17. The device of claim 16, wherein the cover core unit is detachably coupled to the injection molding unit.

18. The device of claim 16, wherein the cutting core unit is detachably coupled to the cover core unit.

19. The device of claim 16, wherein the cylinder unit is detachably coupled to a housing unit.

20. The device of claim 16, wherein the cover core unit comprises:
a cover core main body having a first gate groove defined therein facing the gate; and
a cover core extension block having a first passing-through hole defined therein through which the cutting unit passes and being configured to support the cutting core unit.
